(19) United States
(12) Patent Application Publication
(10) Pub. No.: US 2012/0282456 A1
(43) Pub. Date: Nov. 8, 2012

(54) EPOXY RESIN COMPOSITES AND METHODS OF USE THEREOF

(75) Inventors: Wallace Gregory Sawyer, Gainesville, FL (US); Jennifer Vail, Gainesville, FL (US)

(73) Assignee: UNIVERSITY OF FLORIDA RESEARCH FOUNDATION, INC., Gainesville, FL (US)

(21) Appl. No.: 13/461,136

(22) Filed: May 1, 2012

Related U.S. Application Data
(60) Provisional application No. 61/481,302, filed on May 2, 2011.

(51) Int. Cl. C10M 145/18; C10M 125/02; C10M 125/22; B32B 5/16; C10M 125/10; C10M 147/02; B82Y 30/00

(52) U.S. Cl. 428/327; 508/304; 508/172; 508/165; 508/131; 508/182; 508/167; 977/773

(57) ABSTRACT

Embodiments of the present disclosure provide for epoxy resin composites, methods of making the epoxy nanocomposites, methods of using the nanocomposites, articles, methods of using articles, and the like.

### CROSS-REFERENCE TO RELATED APPLICATION

This application claims priority to U.S. provisional application entitled “EPOXY RESIN COMPOSITES AND METHODS OF USE THEREOF,” having Ser. No. 61/481,302, filed on May 2, 2011, which is entirely incorporated herein by reference.

### BACKGROUND

Solid lubrication offers many benefits over conventional oil-based hydrodynamic and boundary lubrication. Solid lubrication systems are generally more compact and less costly than oil lubricated systems since pumps, lines, filters and reservoirs are usually required in oil lubricated systems. Greases can contaminate the product of the system being lubricated, making it undesirable for food processing and both grease and oil outgas in vacuum precluding their use in space applications. Thus, there is a need in the art for solid lubricants.

### SUMMARY

Embodiments of the present disclosure provide for epoxy resin composites, methods of making the epoxy nanocomposites, methods of using the nanocomposites, articles, methods of using articles, and the like.

An embodiment of the present disclosure includes a composite that includes: an epoxy resin particle having a plurality of solid lubricant nanoparticles disposed on the outer surface of the epoxy resin particle.

An embodiment of the present disclosure includes an article that includes: a composite disposed on a surface of the article, wherein the composite includes an epoxy resin particle having a plurality of solid lubricant nanoparticles disposed on the outer surface of the epoxy resin particle.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims. Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed. Terms defined in references that are incorporated by reference do not alter definitions of terms defined in the present disclosure or should such terms be used to define terms in the present disclosure they should only be used in a manner that is inconsistent with the present disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, physics, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

“Aliphatic group” refers to a saturated or unsaturated, linear or branched hydrocarbon group and encompasses alkyl, alkenyl, and alkynyl groups, for example.

“Alkyl” refers to a monovalent group derived from a straight or branched chain saturated hydrocarbon by the removal of a single hydrogen atom. Exemplary alkyl groups include methyl, ethyl, n- and iso-propyl, cetyl, and the like.

“Cycloalkyl” refers to a saturated alicyclic hydrocarbon such as cyclopropane, cyclobutane, cyclopentane, cyclohexane, and the like.

“Alkylene” refers to a divalent group derived from a straight or branched chain saturated hydrocarbon by the removal of two hydrogen atoms. Exemplary alkylene groups include methylene, ethylene, propylene, and the like.

“Amido group” and “amide” refer to a group of formula —C(O)NY1Y2, where Y1 and Y2 are independently selected from H, alkyl, alkylene, aryl and arylalkyl.

“Amino group” and “amine” refer to a group of formula —NY3Y4, where Y3 and Y4 are independently selected from H, alkyl, alkylene, aryl, and arylalkyl.

“Amidoamine group” or “amidoamine” refer to compounds having an amine group and an amide group.

### Discussion

Embodiments of the present disclosure provide for epoxy resin composites (also referred to as “epoxy resin nanocomposite”), methods of making the epoxy nanocomposites, methods of using the nanocomposites, articles, methods of using articles, and the like. Embodiments of the present disclosure relate to articles having superior tribological properties. In particular, embodiments of the present disclosure have improved wear resistance and/or lubricity, which can reduce maintenance of articles having the epoxy nanocomposite disposed thereon and lost production time. Although not intending to be bound by theory, it appears that the combination of the epoxy resin particle and the solid lubricant nanoparticles produces a synergetic affect on reducing the friction coefficient and steady state wear rate.

Embodiments of the nanocomposite can include an epoxy resin particle having a plurality of solid lubricant nanoparticles disposed on the outer surface of the epoxy resin particle. The solid lubricant particle can include 1 to 100% coverage of the epoxy resin particle, about 5 to 75% coverage of the epoxy resin particle, about 5 to 50% coverage of the epoxy particle, or about 5 to 30% coverage of the epoxy resin particle.

In an embodiment, the epoxy resin particle can be made from the reaction of an epoxy resin and a hardener. In an embodiment, the epoxy resin can be made of a material such as a glycidyl epoxy resin, non-glycidyl epoxy resin (e.g., cycloaliphatic and aliphatic epoxy resins), and a combination thereof. In an embodiment, the glycidyl epoxy resin can include glycidyl-ether (e.g., diglycidyl ether of bisphenol-A (DGEBA) and novolac epoxy resin), glycidyl-ester, and glycidyl-amine. In an embodiment, the hardener can include an amine, a polyamide, an amidoamine, a phenolic resin, a Lewis acid, an organic base, a thiol, an anhydride, an isocyanate, and a polymercaptan. Methods of making the epoxy resin particle from the reaction of an epoxy resin and a hardener is known.

In an embodiment, the epoxy resin particle may have any shape, including substantially spherical or spherical, irregular particles, or high or low aspect ratio particles such as needles, rods, whiskers, fibers, or platelets. In some embodiments, the particles can have a size distribution with at least one submicron dimension. The particle shapes may be round or faceted and may be substantially fully dense or have some degree of porosity. Faceted shapes may include needle-like sharp points or multiple, substantially planar faces. The particles may be composed of individual primary particles. Alternatively, some or all of the particles may be in the form of an aggregation or agglomeration of such primary particles. In some embodiments, partially agglomerated particles have an overall shape which can be irregular or fractal in character. In some instances, the particles exhibit substantial internal porosity, either by virtue of the partially agglomerated state or as a consequence of the preparation procedure used.

In an embodiment, the epoxy resin particle is substantially spherical or spherical and can have a diameter of about 100 nm to 100 micrometers, or about 1 micrometer to 10 micrometers. In an embodiment, the epoxy resin particle can have any shape and it largest dimension (e.g., length, width, or height) can be about 100 nm to 100 micrometers, or about 1 micrometer to 10 micrometers

In an embodiment, the nanoparticle can be selected from: a fluoropolymer nanoparticle, a zinc oxide nanoparticle (e.g., ZnO nanoparticle), an aluminum oxide nanoparticle (e.g., Al₂O₃ nanoparticle), a silica nanoparticle (e.g., SiO₂), a titanium dioxide nanoparticle (e.g., TiO₂ nanoparticle), a graphite nanoparticle, a molybdenum disulfide nanoparticle (e.g., MoS₂ nanoparticle), and a combination thereof.

In an embodiment, the nanoparticle may have any shape, including substantially spherical or spherical, irregular particles, or high or low aspect ratio particles such as needles, rods, whiskers, fibers, or platelets. In some embodiments, the nanoparticles can have a size distribution with at least one submicron dimension. The nanoparticle shapes may be round or faceted and may be substantially fully dense or have some degree of porosity. Faceted shapes may include needle-like sharp points or multiple, substantially planar faces. In an embodiment, the nanoparticle is substantially spherical or spherical and can have a diameter of about 1 to 500 nm, about 10 to 250 nm, or about 10 to 75 nm. In an embodiment, the nanoparticle can have any shape and it largest dimension (e.g., length, width, or height) can be about 1 to 500 nm, about 10 to 250 nm, or about 10 to 75 nm.

In an embodiment, the fluoropolymer nanoparticle can include a fluoropolymer. For that purpose an individual fluoropolymer can be used alone; mixtures or blends of two or more different kinds of fluoropolymers can be used as well. Fluoropolymers useful in the practice of this disclosure are prepared from at least one unsaturated fluorinated monomer (fluoromonomer). A fluoromonomer suitable for use herein preferably contains about 35 wt % or more fluorine, and preferably about 50 wt % or more fluorine, and can be an olefinic monomer with at least one fluorine or fluoroalkyl group or fluoroalkoxy group attached to a doubly-bonded carbon. In one embodiment, a fluoromonomer suitable for use herein is tetrafluoroethylene (TFE).

An especially useful fluoropolymer is thus polytetrafluoroethylene (PTFE), which refers to (a) polymerized tetrafluoroethylene by itself without any significant comonomer present, i.e. a homopolymer of TFE, and (b) modified PTFE, which is a copolymer of TFE with such small concentrations of comonomer that the melting point of the resultant polymer is not substantially reduced below that of PTFE (reduced, for example, by about 8% or less, about 4% or less, about 2% or less, or about 1% or less). Modified PTFE contains a small amount of comonomer modifier that improves film forming capability during baking (fusing). Comonomers useful for such purpose typically are those that introduce bulky side groups into the molecule, and specific examples of such monomers are described below. The concentration of such a comonomer is preferably less than 1 wt %, and more preferably less than 0.5 wt %, based on the total weight of the TFE and comonomer present in the PTFE. A minimum amount of at least about 0.05 wt % comonomer is preferably used to have a significant beneficial effect on processability. The presence of the comonomer is believed to cause a lowering of the average molecular weight. PTFE (and modified PTFE) typically have a melt creep viscosity of at least about 1×10⁶ Pa·s and preferably at least about 1×10⁸ Pa·s. With such high melt viscosity, the polymer does not flow in the molten state and therefore is not a melt-processible polymer. The measurement of melt creep viscosity is disclosed in col. 4 of U.S. Pat. No. 7,763,680. The high melt viscosity of PTFE arises from its extremely high molecular weight (Mn), e.g. at least about 10⁶. Additional indicia of this high molecular weight include the high melting temperature of PTFE, which is at least 330° C., usually at least 331° C. and most often at least 332° C. (all measured on first heat). The non-melt flowability of the PTFE, arising from its extremely high melt viscosity, manifests itself as a melt flow rate (MFR) of 0 when measured in accordance with ASTM D 1238-10 at 372° C. and using a 5 kg weight. This high melt viscosity also leads to a much lower heat of fusion obtained for the second heat (e.g. up to 55 J/g) as compared to the first heat (e.g. at least 75 J/g) to melt the PTFE, representing a difference of at least 20 J/g. The high melt viscosity of the PTFE reduces the ability of the molten PTFE to recrystallize upon cooling from the first heating. The high melt viscosity of PTFE enables its standard specific gravity (SSG) to be measured, which measurement procedure (ASTM D 4894-07, also described in U.S. Pat. No. 4,036,802) includes sintering the SSG sample free standing (without containment) above its melting temperature without change in dimension of the SSG sample. The SSG sample does not flow during the sintering.

Low molecular weight PTFE is commonly known as PTFE micropowder, which distinguishes it from the PTFE described above. The molecular weight of PTFE micropowder is low relative to PTFE, i.e. the molecular weight (Mn) is generally in the range of 10⁴ to 10⁵. The result of this lower molecular weight of PTFE micropowder is that it has fluidity in the molten state, in contrast to PTFE which is not melt flowable. The melt flowability of PTFE micropowder can be characterized by a melt flow rate (MFR) of at least about 0.01 g/10 min, preferably at least about 0.1 g/10 min, more preferably at least about 5 g/10 min, and still more preferably at least about 10 g/10 min., as measured in accordance with ASTM D 1238-10, at 372° C. using a 5 kg weight on the molten polymer.

While PTFE micropowder is characterized by melt flowability because of its low molecular weight, the PTFE micropowder by itself is not melt fabricable, i.e. an article molded from the melt of PTFE micropowder has extreme brittleness, and an extruded filament of PTFE micropowder, for example, is so brittle that it breaks upon flexing. Because of its low molecular weight (relative to non-melt-flowable PTFE), PTFE micropowder has no strength, and compression molded plaques for tensile or flex testing generally cannot be made from PTFE micropowder because the plaques crack or crumble when removed from the compression mold, which prevents testing for either the tensile property or the MIT Flex Life. Accordingly, the micropowder is assigned zero tensile strength and an MIT Flex Life of zero cycles. In contrast, PTFE is flexible, rather than brittle, as indicated for example by an MIT flex life [ASTM D-2176-97a(2007)], using an 8 mil (0.21 mm) thick compression molded film] of at least 1000 cycles, preferably at least 2000 cycles. As a result, PTFE micropowder finds use as a blend component with other polymers such as PTFE itself and/or copolymers of TFE with other monomers such as those described below.

In other embodiments, a fluoromonomer suitable for use herein, by itself to prepare a homopolymer or in copolymerization with other comonomers such as TFE, can be represented by the structure of the following Formula I:

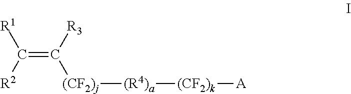

wherein R¹ and R² are each independently selected from H, F and Cl;
R³ is H, F, or a C₁˜C₁₂, or C₁˜C₈, or C₁˜C₆, or C₁˜C₄ straight-chain or branched, or a C₃˜C₁₂, or C₃˜C₈, or C₃˜C₆ cyclic, substituted or unsubstituted, alkyl radical; R⁴ is a C₁˜C₁₂, or C₃˜C₈, or C₃˜C₆, or C₁˜C₄ straight-chain or branched, or a C₃˜C₁₂, or C₃˜C₈, or C₃˜C₆ cyclic, substituted or unsubstituted, alkylene radical; A is H, F or a functional group; a is 0 or 1; and j and k are each independently 0 to 10; provided that, when a, j and k are all 0, at least one of R¹, R², R³ and A is not F.

An unsubstituted alkyl or alkylene radical as described above contains no atoms other than carbon and hydrogen. In a substituted hydrocarbyl radical, one or more halogens selected from CL and F can be optionally substituted for one or more hydrogens; and/or one or more heteroatoms selected from O, N, S and P can optionally be substituted for any one or more of the in-chain (i.e. non-terminal) or in-ring carbon atoms, provided that each heteroatom is separated from the next closest heteroatom by at least one and preferably two carbon atoms, and that no carbon atom is bonded to more than one heteroatom. In other embodiments, at least 20%, or at least 40%, or at least 60%, or at least 80% of the replaceable hydrogen atoms are replaced by fluorine atoms. Preferably a Formula I fluoromonomer is perfluorinated, i.e. all replaceable hydrogen atoms are replaced by fluorine atoms.

In a Formula I compound, a linear R³ radical can, for example, be a C_{b} radical where b is 1, 2, 3, 4, 5, 6, 7, 8, 9, 10, 11 or 12 and the radical can contain from 1 up to 2b+1 fluorine atoms. For example, a C₄ radical can contain from 1 to 9 fluorine atoms. A linear R³ radical is perfluorinated with 2b+1 fluorine atoms, but a branched or cyclic radical will be perfluorinated with fewer than 2b+1 fluorine atoms. In a Formula I compound, a linear R⁴ radical can, for example, be a C_{c} radical where c is 1, 2, 3, 4, 5, 6, 7, 8, 9, 10, 11 or 12 and the radical can contain from 1 to 2c fluorine atoms. For example, a C₆ radical can contain from 1 to 12 fluorine atoms. A linear R⁴ radical is perfluorinated with 2c fluorine atoms, but a branched or cyclic radical will be perfluorinated with fewer than 2c fluorine atoms.

Examples of a C₁˜C₁₂ straight-chain or branched, substituted or unsubstituted, alkyl or alkylene radical suitable for use herein can include or be derived from a methyl, ethyl, n-propyl, i-propyl, n-butyl, sec-butyl, tert-butyl, n-pentyl, n-hexyl, n-octyl, trimethylpentyl, allyl and propargyl radical. Examples of a C₃˜C₁₂ cyclic aliphatic, substituted or unsubstituted, alkyl or alkylene radical suitable for use herein can include or be derived from an alicyclic functional group containing in its structure, as a skeleton, cyclohexane, cyclooctane, norbornane, norbornene, perhydro-anthracene, adamantane, or tricyclo-[5.2.1.0^{2.6}]-decane groups.

Functional groups suitable for use herein as the A substituent in Formula I include ester, alcohol, acid (including carbon-, sulfur-, and phosphorus-based acid) groups, and the salts and halides of such groups; and cyanate, carbamate, and nitrile groups. Specific functional groups that can be used include —SO₂F, —CN, —COON, and —CH₂—Z wherein —Z is —OH, —OCN, —O—(CO)—NH₂, or —OP(O)(OH)₂.

Formula I fluoromonomers that can be homopolymerized include vinyl fluoride (VF), to prepare polyvinyl fluoride (PVF), and vinylidene fluoride (VF₂) to prepare polyvinylidene fluoride (PVDF), and chlorotrifluoroethylene to prepare polychlorotrifluoroethylene. Examples of Formula I fluoromonomers suitable for copolymerization include those in a group such as ethylene, propylene, 1-butene, 1-hexene, 1-octene, chlorotrifluoroethylene (CTFE), trifluoroethylene, hexafluoroisobutylene, vinyl fluoride (VF), vinylidene fluoride (VF₂), and perfluoroolefins such as hexafluoropropylene (HFP), and perfluoroalkyl ethylenes such as perfluoro(butyl) ethylene (PFBE). A preferred monomer for copolymerization with any of the above named comonomers is tetrafluoroethylene (TFE).

In yet other embodiments, a fluoromonomer suitable for use herein, by itself to prepare a homopolymer or in copolymerization with TFE and/or any of the other comonomers described above, can be represented by the structure of the following Formula II:

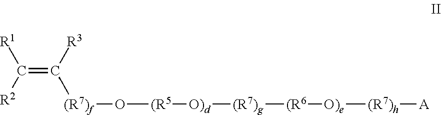

wherein R¹ through R³ and A are each as set forth above with respect to Formula I; d and e are each independently 0 to 10; f, g and h are each independently 0 or 1; and R⁵ through R⁷ are the same radicals as described above with respect to R⁴ in Formula I except that when d and e are both non-zero and g is zero, R⁵ and R⁶ are different R⁴ radicals.

Formula II compounds introduce ether functionality into fluoropolymers suitable for use herein, and include fluorovinyl ethers such as those represented by the following formula: CF₂═CF—(O—CF₂CFR¹¹)ₕ—O—CF₂CFR¹²SO₂F, wherein R¹¹ and R¹² are each independently selected from F, Cl or a perfluorinated alkyl group having 1 to 10 carbon atoms, and h =0, 1 or 2. Examples of polymers of this type that are disclosed in U.S. Pat. No. 3,282,875 include CF₂═CF—O—CF₂CF(CF₃)—O—0 CF₂CF₂SO₂F and perfluoro(3,6-dioxa-4-methyl-7-octenesulfonyl fluoride), and examples that are disclosed in U.S. Pat. Nos. 4,358,545 and 4,940,525 include CF₂═CF—O—CF₂CF₂SO₂F. Another example of a Formula II compound is CF₂═CF—O—CF₂—CF(CF₃)—O—CF₂CF₂CO₂CH₃, the methyl ester of perfluoro(4,7-dioxa-5-methyl-8-nonenecarboxylic acid), as disclosed in U.S. Pat. No. 4,552,631. Similar fluorovinyl ethers with functionality of nitrile, cyanate, carbamate, and phosphonic acid are disclosed in U.S. Pat. Nos. 5,637,748, 6,300,445 and 6,177,196. Methods for making fluoroethers suitable for use herein are set forth in the U.S. patents listed above in this paragraph, and each of the U.S. patents listed above in this paragraph is by this reference incorporated in its entirety as a part hereof for all purposes.

Particular Formula II compounds suitable for use herein as a comonomer include fluorovinyl ethers such as perfluoro(allyl vinyl ether) and perfluoro(butenyl vinyl ether). Preferred fluorovinyl ethers include perfluoro(alkyl vinyl ethers) (PAVE), where the alkyl group contains 1 to 5 carbon atoms, with perfluoro(ethyl vinyl ether) (PEVE) and perfluoro(propyl vinyl ether) (PPVE), and perfluoro(methyl vinyl ether) (PMVE) being preferred.

In yet other embodiments, a fluoromonomer suitable for use herein, by itself to prepare a homopolymer or in copolymerization with TFE and/or any of the other comonomers described above, can be represented by the structure of the following Formula III:

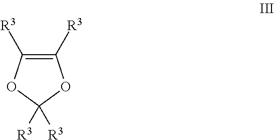

wherein each R³ is independently as described above in relation to Formula I. Suitable Formula III monomers include perfluoro-2,2-dimethyl-1,3-dioxole (PDD).

In yet other embodiments, a fluoromonomer suitable for use herein, by itself to prepare a homopolymer or in copolymerization with TFE and/or any of the other comonomers described above, can be represented by the structure of the following Formula IV:

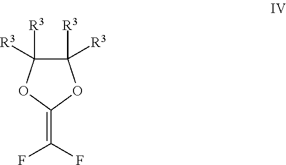

wherein each R³ is independently as described above in relation to Formula I. Suitable Formula IV monomers include perfluoro-2-methylene-4-methyl-1,3-dioxolane (PMD).

In various embodiments, fluoropolymer copolymers suitable for use herein can be prepared from any two, three, four or five of these monomers: TFE and a Formula I, II, Ill and IV monomer. The following are thus representative combinations that are available: TFE/Formula I; TFE/Formula II; TFE/Formula III; TFE/Formula IV; TFE/Formula I/Formula II; TFE/Formula I/Formula III; TFE/Formula I/Formula IV; Formula I/Formula II; Formula I/Formula III; and Formula I/Formula IV. Provided that at least two of the five kinds of monomers are used, a unit derived from each monomer can be present in the final copolymer in an amount of at least about 1 wt %, or at least about 5 wt %, or at least about 10 wt %, or at least about 15 wt %, or at least about 20 wt %, and yet no more than about 99 wt %, or no more than about 95 wt %, or no more than about 90 wt %, or no more than about 85 wt %, or no more than about 80 wt % (based on the weight of the final copolymer); with the balance being made up of one, two, three or all of the other five kinds of monomers.

A fluoropolymer as used herein can also be a mixture of two or more of the homo- and/or copolymers described above, which is usually achieved by dry blending. A fluoropolymer as used herein can also, however, be a polymer alloy prepared from two or more of the homo- and/or copolymers described above, which can be achieved by melt kneading the polymer together such that there is mutual dissolution of the polymer, chemical bonding between the polymers, or dispersion of domains of one of the polymers in a matrix of the other.

Tetrafluoroethylene polymers suitable for use herein can be produced by aqueous polymerization (as described in U.S. Pat. No. 3,635, 926) or polymerization in a perhalogenated solvent (U.S. Pat. No. 3,642, 742) or hybrid processes involving both aqueous and perhalogenated phases (U.S. Pat. No. 4,499,249). Free radical polymerization initiators and chain transfer agents are used in these polymerizations and have been widely discussed in the literature. For example, persulfate initiators and alkane chain transfer agents are described for aqueous polymerization of TFE/PAVE copolymers. Fluorinated peroxide initiators and alcohols, halogenated alkanes, and fluorinated alcohols are described for nonaqueous or aqueous/nonaqueous hybrid polymerizations.

Various fluoropolymers suitable for use herein include those that are thermoplastic, which are fluoropolymers that, at room temperature, are below their glass transition temperature (if amorphous), or below their melting point (if semi-crystalline), and that become soft when heated and become rigid again when cooled without the occurrence of any appreciable chemical change. A semi-crystalline thermoplastic fluoropolymer can have a heat of fusion of at least about 1 J/g, or at least about 4 J/g, or at least about 8 J/g, when measured by Differential Scanning calorimetry (DSC) at a heating rate of 10° C./min (according to ASTM D 3418-08). Various fluoropolymers suitable for use herein can additionally or alternatively be characterized as melt-processible, and melt-processible fluoropolymers can also be melt-fabricable. A melt-processible fluoropolymer can be processed in the molten state, i.e. fabricated from the melt using conventional processing equipment such as extruders and injection molding machines, into shaped articles such as films, fibers and tubes. A melt-fabricable fluoropolymer can be used to produce fabricated articles that exhibit sufficient strength and toughness to be useful for their intended purpose despite having been processed in the molten state. This useful strength is often indicated by a lack of brittleness in the fabricated article, and/or an MIT Flex Life of at least about 1000 cycles, or at least about 2000 cycles (measured as described above), for the fluoropolymer itself.

Examples of thermoplastic, melt-processible and/or melt-fabricable fluoropolymers include copolymers of tetrafluoroethylene (TFE) and at least one fluorinated copolymerizable monomer (comonomer) present in the polymer in sufficient amount to reduce the melting point of the copolymer below that of PTFE, e.g. to a melting temperature no greater than 315° C. Such a TFE copolymer typically incorporates an amount of comonomer into the copolymer in order to provide a copolymer which has a melt flow rate (MFR) of at least about 1, or at least about 5, or at least about 10, or at least about 20, or at least about 30, and yet no more than about 100, or no more than about 90, or no more than about 80, or no more than about 70, or no more than about 60, as measured according to ASTM D-1238-10 using a weight on the molten polymer and melt temperature which is standard for the specific copolymer. Preferably, the melt viscosity is at least about 10² Pa·s, more preferably, will range from about 10² Pa·s to about 10⁶ Pa·s, most preferably about 10³ to about 10⁵ Pa·s. Melt viscosity in Pa·s is 531,700/MFR in g/10 min.

In general, thermoplastic, melt-processible and/or melt-fabricable fluoropolymers as used herein include copolymers that contain at least about 40 mol %, or at least about 45 mol %, or at least about 50 mol %, or at least about 55 mol %, or at least about 60 mol %, and yet no more than about 99 mol %, or no more than about 90 mol %, or no more than about 85 mol %, or no more than about 80 mol %, or no more than about 75 mol % TFE; and at least about 1 mol %, or at least about 5 mol %, or at least about 10 mol %, or at least about 15 mol %, or at least about 20 mol %, and yet no more than about 60 mol %, or no more than about 55 mol %, or no more than about 50 mol %, or no more than about 45 mol %, or no more than about 40 mol % of at least one other monomer. Suitable comonomers to polymerize with TFE to form melt-processible fluoropolymers include a Formula I, II, Ill and/or IV compound; and, in particular, a perfluoroolefin having 3 to 8 carbon atoms [such as hexafluoropropylene (HFP)], and/or perfluoro(alkyl vinyl ethers) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers. Preferred TFE copolymers include FEP (TFE/HFP copolymer), PFA (TFE/PAVE copolymer), TFE/HFP/PAVE wherein PAVE is PEVE and/or PPVE, MFA (TFE/PMVE/PAVE wherein the alkyl group of PAVE has at least two carbon atoms) and THV (TFE/HFP/VF₂). Additional melt-processible fluoropolymers are the copolymers of ethylene (E) or propylene (P) with TFE or chlorinated TFE (CTFE), notably ETFE, ECTFE and PCTFE. Also useful in the same manner are film-forming polymers of polyvinylidene fluoride (PVDF) and copolymers of vinylidene fluoride as well as polyvinyl fluoride (PVF) and copolymers of vinyl fluoride.

Fluoropolymers that are thermoplastic, melt-processible and/or melt-fabricable are in general characterized by a melt flow rate as described above, and can be distinguished from fluoroelastomers, which typically have a glass transition temperature below about 25° C., exhibit little or no crystallinity at room temperature, and/or have a combination of low flex modulus, high elongation, and rapid recovery from deformation. Fluoroelastomers can also be characterized, in various applications, by the definition in ASTM Special Technical Bulletin No. 184 under which they can be stretched (at room temperature) to twice their intrinsic length, and, once released after being held under tension for 5 minutes, return to within 10% of their initial length in the same time.

Fluoropolymers suitable for use herein thus also include fluoroelastomers (fluorocarbon elastomers), which typically contain at least about 25 wt %, or at least about 35 wt %, or at least about 45 wt %, and yet no more than about 70 wt %, or no more than about 60 wt %, or no more than about 50 wt % (based on the total weight of the fluoroelastomer), of a first copolymerized fluorinated monomer such as vinylidene fluoride (VF₂) or TFE; with the remaining copolymerized units in the fluoroelstomer being selected from other, different fluoro-monomers such as a Formula I, II, Ill and/or IV compound; and, in particular, hydrocarbon olefins. Fluoroelastomers may also, optionally, comprise units of one or more cure site monomers. When present, copolymerized cure site monomers are typically at a level of 0.05 to 7 wt %, based on total weight of fluorocarbon elastomer. Examples of suitable cure site monomers include: (i) bromine-, iodine-, or chlorine-containing fluorinated olefins or fluorinated vinyl ethers; (ii) nitrile group-containing fluorinated olefins or fluorinated vinyl ethers; (iii) perfluoro(2-phenoxypropyl vinyl ether); and (iv) non-conjugated dienes.

Preferred TFE-based fluoroelastomer copolymers include TFE/PMVE, TFE/PMVE/E, TFE/P and TFE/P/VF₂. Preferred VF₂ based fluorocarbon elastomer copolymers include VF₂/HFP, VF₂/HFP/TFE, and VF₂/PMVE/TFE. Any of these elastomer copolymers may further comprise units of cure site monomer.

Embodiments of the present disclosure include making the epoxy nanocomposite by mixing, including hand mixing, ultrasonication, jet-milling, and ball milling.

In an embodiment, the epoxy nanocomposite can be disposed (e.g., sprayed, painted, and the like) onto the surface or a portion of the surface exposed to friction. In an embodiment, the articles can be used in low friction applications. The types of articles can vary greatly and include articles where reduced friction is advantageous. In general, an embodiment of the article can have one or more sliding surfaces or surfaces in contact with another structures surface. The articles can have a variety of shapes and cross sections. In an embodiment, the shape of the article can be a simple geometrical shape (e.g., spherical, polygonal, and the like) or a complex geometrical shape (e.g., irregular shapes). In general, the article can have a cross-sectional shape including, but not limited to, a polygon, a curved cross-section, irregular, and combinations thereof.

Embodiments of the articles can be used in many structures, parts, and components in the in the automotive, industrial, aerospace industries, and sporting equipment industries, to name but a few industries where articles having superior tribology characteristics are advantageous. The article can be used in many different applications including, but not limited to, mechanical parts (e.g., bearing, joints, pistons, bushings, sockets, seals, gaskets, etc.), structures having load bearing surfaces, sporting equipment, machine parts and equipment, and the like.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

1. A composite, comprising:
an epoxy resin particle having a plurality of solid lubricant nanoparticles disposed on the outer surface of the epoxy resin particle.

2. The composite of claim 1, wherein the solid lubricant nanoparticles cover about 5 to 30% of the epoxy resin particle.

3. The composite of claim 1, wherein the epoxy resin particle is made of a material selected from the group consisting of: a glycidyl epoxy resin, a non-glycidyl epoxy resin, and a combination thereof.

4. The composite of claim 3, wherein the non-glycidyl epoxy resin is selected from the group consisting of: a cycloaliphatic epoxy resin, an aliphatic epoxy resin, and a combination thereof.

5. The composite of claim 3, wherein the glycidyl epoxy resin is selected from the group consisting of: a glycidyl-ether epoxy resin, a glycidyl-ester epoxy resin, a glycidyl-amine epoxy resin, and a combination thereof.

6. The composite of claim 1, wherein the solid lubricant nanoparticle is selected from the group consisting of: a fluoropolymer nanoparticle, a zinc oxide nanoparticle, an aluminum oxide nanoparticle, a silica nanoparticle, a titanium dioxide nanoparticle, a graphite nanoparticle, a molybdenum disulfide nanoparticle, and a combination thereof.

7. The composite of claim 6, wherein the fluoropolymer nanoparticle includes polytetrafluoroethylene (PTFE).

8. The composite of claim 6, wherein the epoxy resin particle has a largest dimension of about 100 nm to 100 micrometers.

9. The composite of claim 6, wherein the epoxy resin particle has a largest dimension of about 1 to 500 nm.

10. An article, comprising: a composite disposed on a surface of the article, wherein the composite includes an epoxy resin particle having a plurality of solid lubricant nanoparticles disposed on the outer surface of the epoxy resin particle.

11. The article of claim 10, wherein the composite is disposed on a surface of a mechanical part selected from the group consisting of: a bearing, a joint, a piston, a bushing, a socket, a seal, and a gasket.

12. The article of claim 10, wherein the composite forms a layer on the surface that is about 0.1 to 1000 micrometers thick.

13. The article of claim 10, wherein the solid lubricant nanoparticles cover about 5 to 30% of the epoxy resin particle.

14. The article of claim 10, wherein the epoxy resin particle is made of a material selected from the group consisting of: a glycidyl epoxy resin, a non-glycidyl epoxy resin, and a combination thereof.

15. The article of claim 10, wherein the solid lubricant nanoparticle is selected from the group consisting of: a fluoropolymer nanoparticle, a zinc oxide nanoparticle, an aluminum oxide nanoparticle, a silica nanoparticle, a titanium dioxide nanoparticle, a graphite nanoparticle, a molybdenum disulfide nanoparticle, and a combination thereof.

16. The article of claim 15, wherein the fluoropolymer nanoparticle includes polytetrafluoroethylene (PTFE).

17. The article of claim 10, wherein the epoxy resin particle has a largest dimension of about 100 nm to 100 micrometers.

18. The article of claim 17, wherein the epoxy resin particle has a largest dimension of about 1 to 500 nm.
